(19) United States
(12) Patent Application Publication
(10) Pub. No.: US 2016/0202874 A1
(43) Pub. Date: Jul. 14, 2016

(54) System and method for generating, interacting with and inserting web browser displayable and non-displayable content into flight simulation systems

(71) Applicant: Marcin Lizer, Bridel (LU)

(72) Inventor: Marcin Lizer, Bridel (LU)

(21) Appl. No.: 14/951,640

(22) Filed: Nov. 25, 2015

Related U.S. Application Data
(60) Provisional application No. 62/101,406, filed on Jan. 9, 2015.

(51) Int. Cl. G06F 3/0481; G06T 19/00; H04L 29/08; G06F 17/22

(52) U.S. Cl. CPC G06F 3/04815; G06F 17/2247; G06T 19/003; H04L 67/02; G06T 2200/24

(57) ABSTRACT

A system and method for generating, interacting with and inserting web browser displayable and non-displayable content into flight simulation system, the system including web page parsing functionality operative to parse the web pages, thereby generating web browser displayable and non-displayable content that can be used by flight simulation system to simulate the model of the aircraft its system and the environment in which they operate and a system and method of generating HTML content based on the flight simulation data.

### CROSS-REFERENCE TO RELATED APPLICATIONS

This application claims priority from Provisional Application Serial No. 62/101406, filed Jan. 9, 2015.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

### Field of the Invention

Present invention is directed to a system and method for generating, interacting with and inserting web browser displayable and non-displayable content into flight simulation software and for generating HTML content based on the simulation data. The primary use of the invention is to simplify and streamline the way of developing the model of simulated aircraft/vehicle, its systems and the environment in which they operate.

### BACKGROUND OF THE INVENTION

This invention relates generally to the field of flight simulation and more particularly to a process of providing displayable and non-displayable content for the flight simulation system and its interaction with the user. The current state of art provides various flight simulation systems that simulate aircraft flight and the environment in which it flies. In the embodiment of the present invention, a new way of providing the content for an aircraft model, its systems and the environment they operate is introduced. The main objective of the invention is to simplify and streamline the development of the content for flight simulation. The limitations and primary deficiency of the prior art methods and techniques used for building existing aircraft models/vehicles and 3D models of the environment built for flight simulation system are the costs of development as it requires expert knowledge in the field of software development and significant effort which is normally required for low level GPU programming (OpenGL, DirectX, GDI etc.). This is especially true when providing rich content for example sophisticated graphics and sounds. Flight simulation systems have a long history, there are several software flight simulation applications among them Microsoft Flight Simulator, X-Plane developed by Laminar Research, Prepar3d developed by Lockheed Martin, open source project called Flight Gear and military simulations like TitanIM, Digital Combat Simulator(DCS). All of those systems are enabled for custom integration allowing independent parties to provide own virtual models of the aircraft/vehicle and the 3D virtual environment in which they operate. At the time the flight simulation systems were developing and evolving, the web browsing phenomenon started by providing displayable and non-displayable content for the users. Web browsers are software applications for retrieving, presenting and traversing information resources on World Wide Web. They are meant for surfing the internet and provide its resources in displayable and non-displayable content for the users browsing the internet, intranet or local web pages. The content is normally defined using HyperText Markup Language (HTML) which is the standard markup language used to create the web pages and Cascading Style Sheets (CSS) that pre-defines the look and layout of the text and other material on the page. The HTML based content can be manipulated using the embedded scripts written in script languages such as JavaScript which affect the behavior of HTML elements on the web page. HTML simplifies the content development thus quickening the process. The latest, 5th version of the HTML standard has three prominent characteristics. First, to strengthen the performance of web page rendering, second to introduce the standard WebGL (Web Graphics Library) for programming GPU (graphics processing units) thus reducing use of plug-ins, and third to introduce the web sockets protocol which defines a duplex communication channel that operates through a single socket over the web thus represents a colossal advance, especially for the real-time, event-driven web applications. Taking into account all the advantages of web pages development, the present invention is based on the following ideas: 1) An idea to employ web browser functionality that will independently generate the displayable and non-displayable content that will be integrated with flight simulation system, notably for the simulated aircraft/vehicle models, its systems and the environment in which they operate. 2) An idea to employ web server supporting web socket protocol to generate HTML content with the input of simulation data that will use HTTP/HTTPS and web socket protocol for duplex communication between web server and browsed web page.

### SUMMARY OF THE INVENTION

What is needed is a system and a method for building models of the aircrafts/vehicles, its systems and 3D objects for flight simulation systems that is economical and efficient. Thus, the primary object of the invention is to provide the virtual aircraft designers a system and a method for generating displayable and non-displayable content, based on the simulation data, that can be used for the flight simulation purpose with the use of web browser parsing functionality operative to parse the web pages, thereby generating web browser displayable and non-displayable content. The secondary object of the invention is a system and method to employ web server supporting web sockets protocol that process simulation data received from flight simulation system and delivers web pages related to the flight simulation. The communication between web server connected to the flight simulator and web browser processing HTML5 content is bi-directional using combination of both HTTP/HTTPS and web socket protocol.

### BRIEF DESCRIPTION OF THE DRAWINGS

The present invention will be understood and appreciated more fully from the following detailed description, taken in conjunction with the drawings in which:

FIG. 1 is a simplified pictorial illustration of the first preferred embodiment of the present invention showing the system and method for building aircraft/vehicle models and its systems for software flight simulation systems with the use of the content generated by web browser.

FIG. 2 is a simplified pictorial illustration of the second preferred embodiment of the present invention showing the systems and methods for building 3D aircraft/vehicle models or 3D environment objects with the use of the generated content by web browser.

FIG. 3 is a simplified pictorial illustration of the tertiary preferred embodiment of the present invention, showing the system and methods for generating and interacting with web pages based on flight simulation data received from flight simulation system.

### DETAILED DESCRIPTION

A detailed description of the preferred embodiments is provided herein. It has to be understood, however, that the present invention may be embodied in various forms. These forms may include, but are not limited, to additional application of this invention in the field of flight simulation. Therefore, specific details disclosed herein are not to be interpreted as limiting, but rather as a basis for the claims and as representative basis for presenting one skilled in the art the ways to employ the present invention in the flight simulation system. It is important to acknowledge that invented system and method can be either embedded directly into the flight simulated system as an integrated part of it and potentially offered as integration framework for 3rd party developers or it can be developed as a separate plugin/add-on of that flight simulation system.

An important feature of the above described invention and, one skilled in the art will appreciate is the fact, that some significant limitations and obstacles imposed by the prior art are effectively eliminated, notably the skills and effort needed to deliver displayable and non-displayable content to be used by flight simulation system. As today's avionics systems e.g. Primary Flight Display (PFD), Multi-Function Display (MFD), Flight Management Systems (FMS), Control Display Unit (CFU), GPS, Synthetic Vision Systems etc. have become very complex in the recent years thus very difficult and time-consuming to simulate using prior-art techniques, HTML5 based content can significantly simplify the development of the simulated systems and reduce the effort. HTML standard was invented mainly for structuring and describing the content which parsed by web browser will be presented to the users surfing the network resources. The spirit of the invention is to: 1) employ in any form the generated by web browser the displayable (e.g. in the form of dynamic bitmap textures) and non-displayable (e.g. sound, state of aircraft system, variables, etc.) content in the flight simulation, 2) allow interaction of the user with the generated content, 3) generate HTML content based on the simulation data which can be then retrieved by any web browser (including embedded into a separate application) on local machine or from remote location for visualization, processing and interaction. Another aspect the skilled in the art will appreciate is that HTML is meant to use World Wide Web resources, which now can be, when using the invention, utilized and easily integrated with the flight simulation system.

### First Preferred Embodiment of the Invention

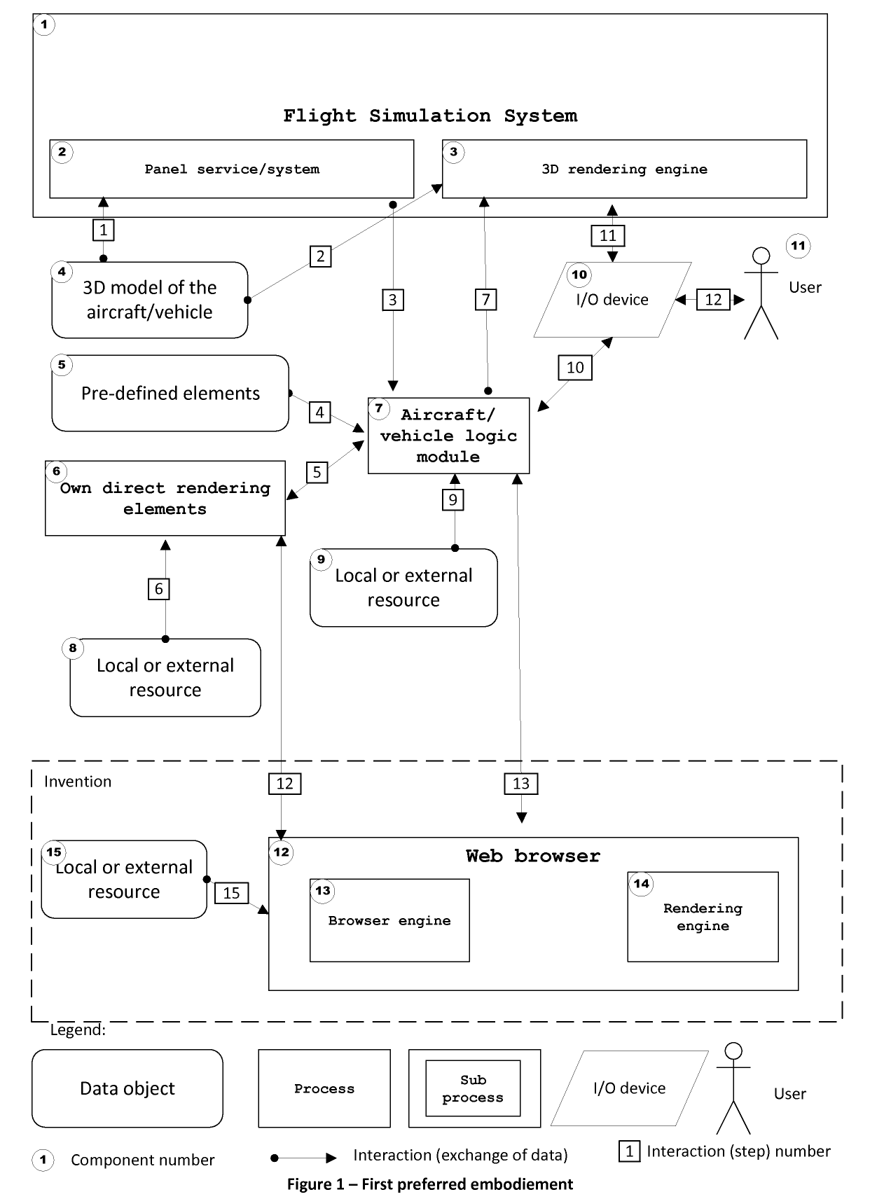

Turning now descriptively to the drawings, in which similar goals of generating dynamic content of the aircraft/vehicle or 3D model of the environment, can be achieved using prior-art techniques or innovative way defined by the present invention, FIG. 1 shows how web browser generated content can be used by flight simulation system and a general technique to embed custom add-on flight simulation elements into the flight simulation system and how they are processed. The technique can be represented in various forms. The invention does not change those forms but includes new elements and methods that streamline significantly the process of providing dynamic content for flight simulation systems. The system and method presented in FIG. 1. representing the first preferred embodiment is comprised of the following components:

Component (1) “Flight simulation system”. It is a computer system that artificially recreates aircraft flight and the environment in which it flies, for pilot training, design, or other purposes. It includes replicating the equations that govern how aircraft fly, how they react to applications of flight controls, the effects of other aircraft systems, and how the aircraft reacts to external factors such as air density, turbulence, wind shear, cloud, precipitation, etc. Flight simulation system is used for a variety of reasons, including entertainment, flight training, the design and development of the aircraft itself, and research into aircraft characteristics and control handling qualities.

Component (2) “Panel service/system” is a sub process (module) of flight simulation system (1) and is used to display and control of the dynamic parts of the 3D model of the aircraft/vehicle that is normally related to the flight controls and avionics systems.

Component (3) “3D Rendering engine” is a sub process of flight simulation system (1) for generating image frames by means of computer programs

Component (4) “3D model of the aircraft” is mathematical representation of any three-dimensional surface of an object. Current state of the art in the domain uses mainly polygonal modeling that is texture mapped.

Component (5) “Pre-defined elements or custom elements” are number (set) of dynamic elements that can be used by panel service/system (2), often used as generic instruments of the vehicle. For example, in Microsoft Flight Simulator and Lockheed Martin Prepar3d there are referred as XML Gauges. In X Plane Flight Simulator they are known as Generic Instruments.

Component (6) “Own direct rendering elements” are custom dynamic elements of the 3D model that is rendered directly into the polygon of the model. For example, in Microsoft Flight Simulator and Lockheed Martin Prepar3d there are referred as C++gauges, DirectX gauges or Custom Textures. In X-Plane they are referred as plugins and are embedded in the custom model (7). Own direct rendering elements (6) could be but are not limited to a dynamic-link/shared libraries loaded by flight simulation system (1) executable.

Component (7) “Aircraft/vehicle logic module” is process that controls the behavior of the model of the aircraft/vehicle, i.e. its flight dynamics, specific systems and controls. For example it could be but is not limited to a dynamic-link/shared library loaded by flight simulation system (1) executable.

Component (8) is a local or external data that can be used by own direct rendering elements (6)

Component (9) is a local or external data that can be used by aircraft/vehicle logic module (7)

Component (10) “I/O device” comprises of input and output devices that the user of the system interacts with. It provides an interface between the user and flight simulation system (1). For example an output device can be a computer screen that shows the virtual world of flight simulation, an input device can be a keyboard, joystick, yoke, pedal system or any device that provides input for flight the simulation system (1). I/O device could be also a supplementary computer system, tablet device, smartphone that shows particular control or controls of the aircraft/vehicle or any simulation data and/or provides input for flight simulation system (1).

Component (11) is a “user” or group of users interacting with the flight simulation system (1).

Referring now to the first preferred embodiment of invention in more detail, the following steps/processes are generally used to draw and interact with the custom model of the aircraft/vehicle that is embedded into flight simulation system:

Steps [1] and [2] represent the process of loading 3D model of the aircraft (4) into the flight simulation system (1). Step [1] loads controls, systems, dynamic elements of the aircraft/vehicle (4) into the Panel Service (2) while step [2] loads 3D model into the 3D rendering engine (3).

In step [3] the flight simulation system (1) invokes the use of aircraft/vehicle logic module (7) which loads its pre-defined (5) and own rendering elements (6) with the means of step [4] and [5]. As elements (6) perform its own rendering, they can use the resources (8) loaded using step [6]. Aircraft/vehicle logic module (7) can also load resources (9) with the means of step [9]. The output [5] of the own rendered elements (6) is transferred synchronously with the 3D rendering engine (3) which means that every visual frame produced by the rendering engine (3) needs to wait until the own rendering process (6) is completed. This often leads to performance loss which is a showstopper for building sophisticated custom models and systems that require lots of processing power, for example Synthetic visual systems used in modern aviation navigation. It has to be noted, that changing the method of generating the content to asynchronous is not the only spirit of the invention, as it is combined with the fact that the content is defined by HTML.

Aircraft/vehicle logic module (7) processes all the inputs coming from components (2), (5), (6), (9), (10) and related to the behavior of the aircraft/vehicle model and produce its output to be rendered in step [7] by 3D rendering engine (3) or exported to output devices (10) that are interfaced by means of Step [12] with the user (11)

Input devices interact directly with flight simulation system (1) using step [11] or provide input for aircraft/vehicle logic module (7) by means of step [10].

The components and steps/processes depicted on FIG. 1 and grouped in the dashed rectangle labeled “Invention” and described below constitutes the first preferred embodiment of the present invention. Those new elements are vital for the invention as they simplify the flight simulation content building process by bringing completely new way of providing the content by employing web browser functionalities. The new components being parts of the invention are the following:

Component (12) “Web browser” normally comprising (but not limited to) two sub-components: “browser engine” (13) which is the interface for querying and manipulating the “rendering engine” (14) responsible for displaying the requested content. In the present invention, web browser process (12) run separately and asynchronously from flight simulation system (1) i.e. producing results asynchronously thus the rendering of flight simulation scene performed by 3D rendering engine (3) does not need to wait for the results of the web browser (12). 3D rendering engine (3) use the results when they are available. That allows minimizing the performance impact of flight simulation process which is a critical factor.

Component (15) is a local or external data that web browser (13) can obtain.

Web browser (12) interacts with flight simulation and provides independently results that can be used for flight simulation purposes. Those are depicted with the following steps in FIG. 1:

In step [12] own rendering elements (6) make a call to web browser (12) to retrieve browser processed content. This request is processed by browser engine (13) with the use of local or external resources retrieved in step [15]. These resources may be or not related to the current simulation data. The result of this process is browser displayable content and non-displayable content (state of process, variables, sound). The displayable content is processed by the rendering engine (14) which provides the results in the form of image frames (for example bitmaps or raster image) that is provided for own direct rendering elements (6) which later puts the image frames in the viewports of 3D rendering engine using steps [5] and [7]. The viewports are normally mapped to the polygons of the 3D model of the aircraft or environment object. This technique is known as texture mapping. The non-displayable content can be retrieved by own direct rendering add-on (6) by means of step [12] or by the aircraft/vehicle logic module (7) by means of step [13]. Aircraft/vehicle logic module (7) which defines the behavior of the aircraft/vehicle and its systems can also make direct calls to the web browser (12) to provide aircraft/vehicle model or its systems related input for browser processing. As the browser processing runs independently from aircraft/vehicle logic module (7) this input can influence the browser processing.

The 3D rendering process (3) of the flight simulation system (1) runs constantly and produces image frames for output display device (10) thus generating motion. Web browser rendering engine (14) runs asynchronously and produces image frames in memory (off-screen rendering) that when available are incorporated in the 3D scene produced by flight simulation system (1).

### Second Preferred Embodiment of the Invention

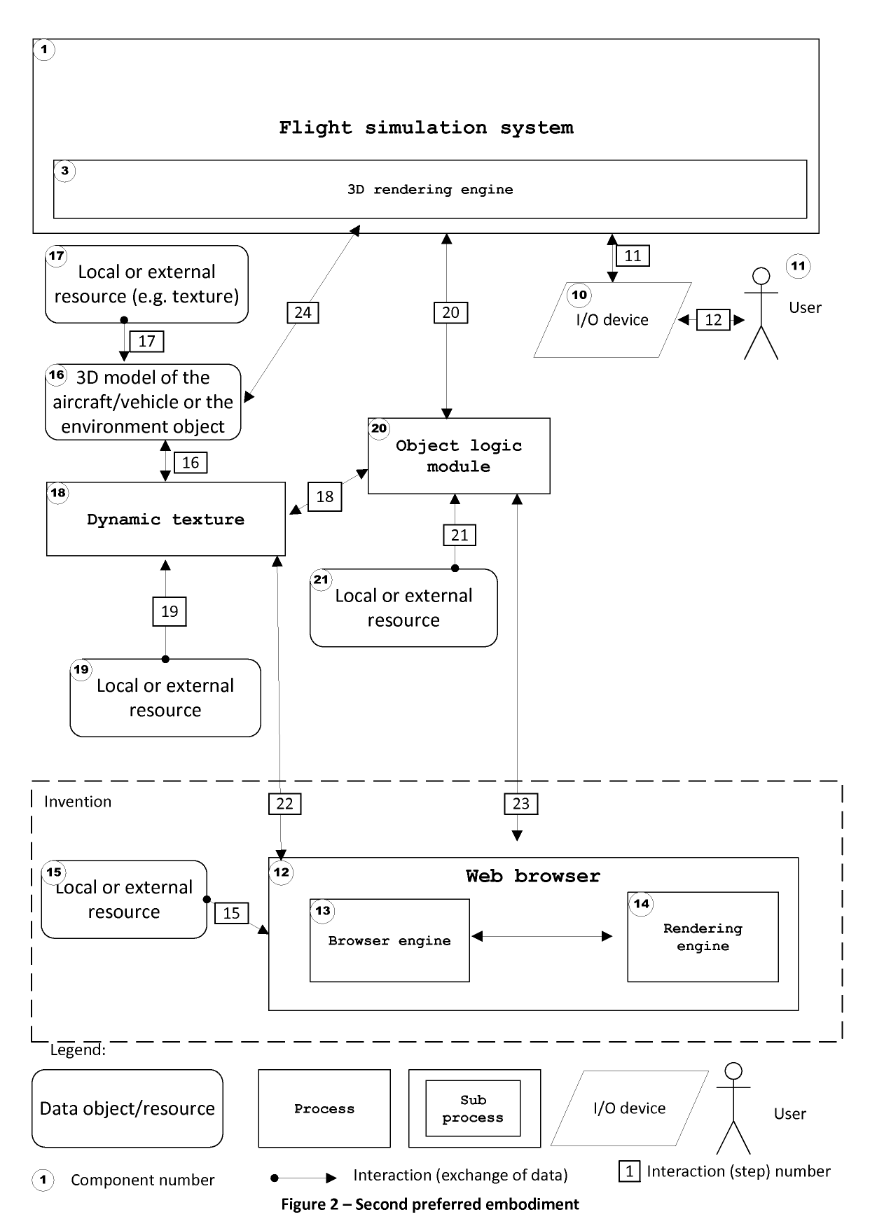

The method presented in FIG. 2 representing the second preferred embodiment is based on the similar concept as in the first embodiment, however with a different purpose. The goal of the first preferred embodiment was to employ web browser to deliver displayable and not displayable content for the aircraft/vehicle and its systems. The goal of the second preferred embodiment is to employ web browser to produce displayable and non-displayable content to be used in the virtual 3D environment in which simulated aircraft/vehicle model operates, notably by producing dynamic textures that are normally used to show virtual world. The presented in FIG. 2 embodiment is comprised of the components (1), (3), (10), (11), (12), (13), (14), (15) used as in the FIG. 1 with addition of the following new components:

Component (16) “3D model of the aircraft/vehicle or environment object” is a mathematical representation of any three-dimensional surface of an object. Prior art in the domain uses mainly polygonal modeling that are texture mapped.

Component (17) is a local or remote resource that 3D model (16) utilize, notable a texture resource that is mapped in the polygonal mesh. For example, in Microsoft Windows systems the textures could be stored as DDS files.

Component (18) is a module/process that instead of providing static resource, it produces dynamic content, notably a texture which changes its visual appearance based on received input. It might have wide usage, for example it could the material of which is 3D object is built, however it could be the texture used to visualize the water, sky, clouds. The presented embodiment does not limit the usage of the dynamic texture. For example this component could be encapsulated but is not limited in a dynamic-link/shared library loaded by flight simulation system (1) executable.

Component (19) is a local or external resource that can be used to provide the output of dynamic texture (18) module.

Component (20) “Object logic module” is a module that controls the behavior of the model object used in the virtual world. For example it could be damage system for 3D model requesting different textures depending on the physical condition of the 3D object or it could be weather system that request different cloud textures depending on the weather conditions. The presented embodiment does not limit the usage of this component, so it has to be understood as any module that request generation of dynamic textures (18). For example this component could be encapsulated but is not limited in a dynamic-link/shared library loaded by flight simulation system (1) executable.

Component (21) is a local or external resource that can be used by the object logic module (20).

Referring now to the second preferred embodiment of invention in more detail, the following steps/processes are generally used to draw 3D objects in the virtual world of flight simulation.

In step [24], the 3D rendering engine (3) of the flight simulation system (1) request the usage of specific 3D model of the aircraft/vehicle or environment (16) object used in the virtual world. The object often represented by not but limited to polygonal mesh is built with local or remote resources (17) that normally represent textures mapped to the polygons of the model. Those resources could be already loaded by the flight simulation system (1) or would be loaded at the moment 3D rendering engine (3) wants to show a scene with the requested object. Step [17] represents the generic process of loading these resources for the use of 3D model or any environmental object (16).

In specific cases, the 3D model of the aircraft or environmental object, instead of using static textures, requests in step [16] the usage of generated by the means of computerized program dynamic textures (18). The dynamic textures (18) can retrieve own local or remote resources (19) by the means of step [19].

The generated dynamic texture (18) is mapped in step [16] to the 3D model of the aircraft/vehicle or environment object (16). As the dynamic texture can have different content every single simulation frame rendered as scene in the flight simulation system (1) thus it may produce an effect of the live virtual world. The generated dynamic texture (16) is transferred to the flight simulation system (1) using step [24] to allow 3D rendering engine (2) displaying it on the output device (10) with the means of step [11] and showing it to the user (11) using step [12].

The behavior of the dynamic texture (18) can be controlled by object logic module (20) with the means of step [21] and the object logic module (20) communicates with the flight simulation system (1) with the means of step [20]. For example the change in the weather conditions in the flight simulation system (1) are transformed to object logic module (20) which request the update of the dynamic textures (18) with the textures of clouds that correspond to the weather. Another case is, for example, when the user selects the airline company for his selected aircraft, this request is transported to the object logic module (20) which requests new textures for the 3D aircraft model that represent the painting corresponding to the selected airline company.

The components and steps/processes depicted on FIG. 2 and grouped in the dashed rectangle labeled “Invention” and described below constitutes the second preferred embodiment of the present invention. Those new elements are vital for the invention as they simplify the flight simulation content building process by bringing completely new way of providing the content by employing web browser functionalities. The new components being parts of the invention (12), (13), (14), (15) are exactly the same as in the first preferred embodiments depicted on FIG. 1, however they serve different purpose that is summarized below:

The dynamic texture component (18) requests the web browser (12) with the use of step [22] to provide the displayable content. Web browser parsing HTML code supported by local or remote resources (15) generate the displayable content in the form of image frames (for example bitmaps) that are transferred as textures to the dynamic texture model which are used for mapping with the polygons of the 3D model of the aircraft/vehicle or the environment object. Non displayable content (for example sound) provided by the web browser is transferred with the means of step [23] to the object logic module (20) for own processing. The browser processing HTML input runs independently and asynchronously from flight simulation system (1) and object logic module (20) however all the components (1), (12), (18), (20) can at any time interact with each other. For example, web browser using web socket protocol could listen to the events from the outside sources (e.g. web servers on the internet). In case of particular event, web browser could update its displayable content and send it to the flight simulation for rendering. Many potential scenarios can be envisages with the presented embodiment of the invention as the spirit of it is to provide displayable and non-displayable for flight simulation that is generated by web browser. Therefore, specific details disclosed in this embodiment are not to be interpreted as limiting, but as a basis for the claims and as representative basis for presenting one skilled in the art the ways to employ the present invention in the flight simulation.

### Tertiary Preferred Embodiment of the Invention

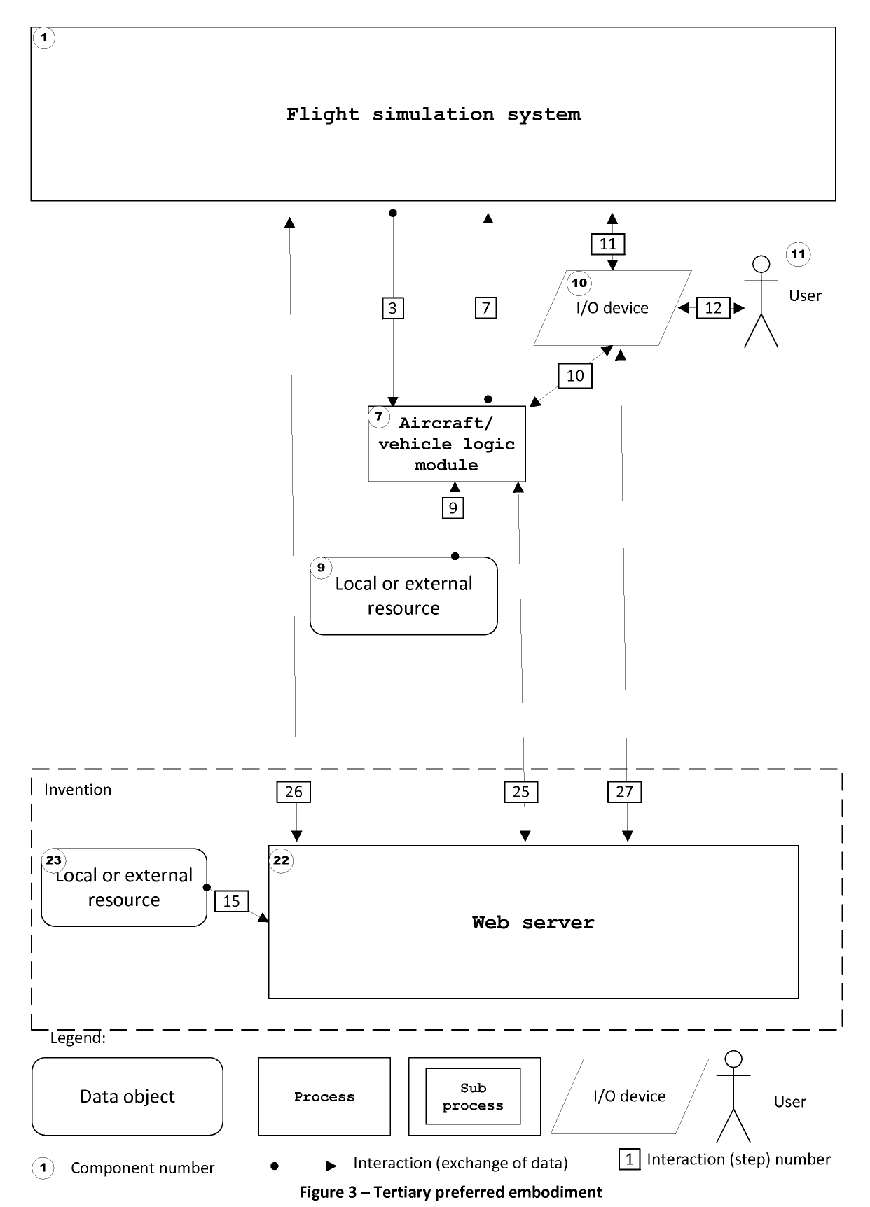

The method presented in FIG. 3 representing the tertiary preferred embodiment is based on the different concept than the once presented in FIG. 1 and FIG. 2. Instead of using web browser to generate displayable (as image frames) and non-displayable content, another idea is exploited which can be summarized as using web server software that using simulation data generates HTML based content. The primary goal of the tertiary preferred embodiment is to deliver real time flight simulation HTML content to be accessible from any web browser installed on local or remote device as separate application or, including embedded in other application. The first major advantage of this embodiment one skilled in the art will appreciate is the fact, that simulation data wrapped in HTML content can be accessed from any software system with installed web browser software (as stand-alone or embedded in another application), for example IOS, Android, Linux, Java, etc. The second major advantage of the presented tertiary embodiment is a fact that generated HTML content based on the simulation data can be easily accessed from remote device using TCP/IP protocol web browser can handle, e.g. HTTP, HTTPS, web socket. The third major advantage is the fact, that the invented flight simulation web server may support web socket protocol which enables generated HTML content to communicate back and forth (full-duplex) with the flight simulation system.

One example of use is to develop HTML page that shows the geographical position of the aircraft. Any web browser connected to TCP/IP network could retrieve web page with the current position of the aircraft. With the use of web socket protocol, any change in the position of the aircraft would be send to web browser, which will be notified of the change and perform necessary action, for example change the position on the displayed map. Another example of use is to use remote device (for example additional PC or tablet device) that with installed web browser simulates one of the control or system of the aircraft. Any changes of the simulation data (e.g. current speed of the aircraft) could be transferred to the web browser (for example to update the display of the speed gauge) and any action performed by user on the web browser could result in the change of simulation data (for example user change the position of the throttle gauge on the web page). Many potential scenarios can be envisages with the presented embodiment of the invention as the spirit of it is to provide HTML that is generated by web server using simulation data retrieved from flight simulation system. Therefore, specific details disclosed in this embodiment are not to be interpreted as limiting, but as a basis for the claims and as representative basis for presenting one skilled in the art the ways to employ the present invention in the flight simulation.

The presented in FIG. 3 embodiment is comprised of the components (1), (7), (9), (10), (11) used as in the FIG. 1 with addition of the following two new components:

Component (22) “Web server” is a computer system that processes requests via HTTP/HTTPS based network protocols. The term can refer either to the entire system, or specifically to the software that accepts and supervises the HTTP/HTTPS requests. The primary function of a web server is to store, process and deliver web pages to clients.

Pages delivered are most frequently HTML documents, which may include images, style sheets and scripts in addition to text content.

Component (23) is local or remote resource that can be accessed from the web server (22)

Referring now to the tertiary preferred embodiment of the invention in more detail, the two scenarios following steps/processes are generally used to generate HTML content based on the simulation data provided by the Flight Simulation system(1):

The process starts in step [27] with the request from the user to view HTML page, or interact with already loaded HTML page, that includes the information from the flight Simulation system (1). The request is normally transferred from any web browser based software installed on I/O device (10). It could be located on the same computers system as the flight simulation system (1) or it could be on a dedicated device like additional computer system, table, smartphone, etc. Web browser requests in the current state of art are encapsulated in HTTP, HTTPS protocol. Web server (22) processes the request to provide HTTP/HTTPS response and HTML output content. As the web page is supposed to contain the flight simulation data, web server (1) communicates with the means of step

with the flight simulation system (1) to retrieve the relevant data which are processed to provide output HTML content. As normally flight simulation system (1) does not provide HTTP/HTTPS interfaces, additional communication channel is needed to allow the web server (22) to retrieve the simulation data from the flight simulation system (1). Additionally, the web server (22) can requests specific model data from aircraft/vehicle logic module (7) with the means of step [25]. The web server returns the data to the user's I/O device (10) using step [27].

Another scenario of the presented embodiment is when the flight simulation system (1) triggers specific event in case it wants to notify the user's I/O device of particular state of the simulation data. In the current state of art, web browsers can utilize web socket protocol to listen to web server messages. In such case, flight simulation system (1) uses step [26] to notify the web server (22) about the event and web server (2) using web socket protocol notifies the web browser software installed on user's I/O device (10) of the change. The event is then processed by web browser and shown to the user as displayable or non-displayable content.

In view of the many possible embodiments to which the principles of the invention may be applied, it should be recognized that the embodiments described above are not the only possible embodiments and should not be taken as a limitation on the scope of the invention. I claim as my invention all that comes within the scope and spirit of the ideas presented in the invention.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is my intent they be deemed within the scope of my invention.

What is claimed is:

1. A system for generating, interacting with and inserting web browser displayable and non-displayable content into a flight simulation system, said system comprising:
web pages defining said displayable and non-displayable content using HTML markup language
web browser and web page parsing functionality operative to parse said web pages
off-screen rendering functionality to generate said web browser displayable content for flight simulation system.
inserting functionality operative to insert said displayable and non-displayable content into the flight simulation system.
interacting functionality operative to allow said web pages interaction with the flight simulation system.

2. A system for generating, interacting with and inserting web browser displayable and non-displayable content into the flight simulation system according to claim 1 wherein said displayable and non-displayable content is used to simulate controls and systems of the simulated aircraft or vehicle.

3. A system for generating, interacting with and inserting web browser displayable and non-displayable content into the flight simulation system according to any preceding claim wherein said displayable and non-displayable content is used to simulate 3D virtual environment in which said simulated aircraft or vehicle operates.

4. A system for generating, interacting with and inserting web browser displayable and non-displayable content into the flight simulation system according to any preceding claim wherein said system comprises insertion functionality operative to display the said displayable content in the flight simulation system.

5. A system for generating, interacting with and inserting web browser displayable and non-displayable content into the flight simulation system according to any preceding claim and wherein said system also comprises state persistence functionality operative to maintain persistent state of said controls and systems of said simulated aircraft or vehicle.

6. A system for generating, interacting with and inserting web browser displayable and non-displayable content into the flight simulation system according to any preceding claim wherein said system comprises web page interaction functionality operative to allow said web page interact with the flight simulation system.

7. A system for generating, interacting with and inserting web browser displayable and non-displayable content into the flight simulation system according to any preceding claim wherein said system is integrated part of the flight simulation system.

8. A system for generating, interacting with and inserting web browser displayable and non-displayable content into the flight simulation system according to any preceding claim wherein said system is built as a plugin/add-on of the flight simulation system

9. A method for generating, interacting with and inserting web browser displayable and non-displayable content into a flight simulation system, said method comprising:
parsing web pages operative to parse said web pages into displayable and non-displayable content;
generating said web browser displayable and non-displayable content for the flight simulation system using off-screen rendering functionality.
inserting said displayable and non-displayable content into the flight simulation system.
interacting said web pages with flight simulation system.

10. A method for generating, interacting with and inserting web browser displayable and non-displayable content into the flight simulation system according to claim 9 and wherein said displayable and non-displayable content is used to simulate controls and systems of the simulated aircraft or vehicle.

11. A method for generating, interacting with and inserting web browser displayable and non-displayable content into the flight simulation system according to claims 9-10 and wherein said displayable and non-displayable content simulates 3D virtual environment in which said simulated aircraft or vehicle operates.

12. A method for generating, interacting with and inserting web browser displayable and non-displayable content into the flight simulation system according to claims 9-11 and wherein said method also comprises maintaining a persistence state of said controls and systems of said simulated aircraft or vehicle.

13. A method for generating, interacting with and inserting web browser displayable and non-displayable content into the flight simulation system according to claims 9-12 and wherein said method comprises inserting the said non displayable content in the flight simulation system.

14. A method for generating, interacting with and inserting web browser displayable and non-displayable content into the flight simulation system according to claims 9-13 and wherein said web page is operative to interact with the flight simulation system.

15. A method for generating, interacting with and inserting web browser displayable and non-displayable content into the flight simulation system according to claims 9-14 wherein said method is built in the flight simulation system.

16. A method for generating, interacting with and inserting web browser displayable and non-displayable content into the flight simulation system according to claims 9-15 wherein said method is built as a plugin/add-on of flight simulation system.

17. A system for generating web page and interacting with a flight simulation system, said system comprising:
web page generating functionality operative to generate web page using a data provided by the flight simulation system generated web page;
interacting functionality operative to allow said web page bidirectional interaction with flight simulation system.

18. A system for generating web page and interacting with a flight simulation system according to claim 17 wherein said system is used to simulate controls and systems of a simulated aircraft or vehicle.

19. A method for generating web page and interacting with a flight simulation system, said method comprising:
generating web page with a data provided by the flight simulation system
bidirectional interacting of said web page with the flight simulation system.

20. A method for generating web page and interacting with the flight simulation system according to claim 19 wherein said method is used to simulate controls and systems of a simulated aircraft or vehicle.
